(19) United States
(12) Patent Application Publication
(10) Pub. No.: US 2010/0307648 A1
(43) Pub. Date: Dec. 9, 2010

(54) DESENSITIZATION BY COATING CRYSTALS OF EXPLOSIVE ENERGY SUBSTANCES, COATED CRYSTALS OF SUCH SUBSTANCES, AND ENERGY MATERIALS

(75) Inventors: Christine Marraud, Chevanceaux (FR); Samuel Marre, Le Havre (FR); Francois Cansell, Pessac (FR); Cyril Aymonier, Begles (FR)

Correspondence Address: HAMRE, SCHUMANN, MUELLER & LARSON, P.C., P.O. BOX 2902, MINNEAPOLIS, MN, 55402-0902, US

(73) Assignee: SNPE MATERIAUX ENERGETIQUES, Paris (FR)

(21) Appl. No.: 12/809,315

(22) PCT Filed: Dec. 18, 2008
(86) PCT No.: PCT/FR2008/052353

§ 371 Date: Jun. 18, 2010

(30) Foreign Application Priority Data
Dec. 19, 2007 (FR) 0760036

(51) Int. Cl. C06B 45/18; B05D 7/00; C06B 45/22

(52) U.S. Cl. 149/11; 427/213.3; 149/3

(57) ABSTRACT

Subjects of the present invention are:
a method of desensitizing crystals of an energetic explosive substance by coating them, said method comprising the deposition, carried out within a fluid, outside the normal temperature and pressure conditions, preferably under supercritical conditions, of a metal and/or polymer film, advantageously of a metal film or of a polymer film, on the surface of said crystals, the metal(s) and/or polymer(s) in question having been firstly dissolved in a solvent;
the coated crystals of an energetic explosive substance obtainable by said method; and
the energetic materials containing said crystals coated by said method and/or said crystals desensitized by said method.

The subjects of the present invention are:
a method of desensitizing crystals of an energetic explosive substance by coating them;
coated crystals of an energetic explosive substance, i.e. such crystals desensitized by coating; and
energetic materials containing said coated crystals and/or crystals desensitized by said method.

The present invention relates more precisely to the coating of crystals of energetic explosive materials with an inorganic (metal) and/or organic (polymer) film so as to reduce the shock sensitivity, friction sensitivity and/or static electricity sensitivity of said crystals and to lower their deflagration-to-detonation transition threshold.

The field of application of the invention covers the whole field of application of energetic materials, especially for the defense industry, the space industry and automotive safety.
The discovery of new, ever more powerful, energetic materials is a priority for companies working in the field of energetic materials. However, the increase in energetic potential of these new molecules, which are in crystalline form, is often accompanied by greater shock, friction and/or static electricity sensitivity and also by an increased probability of transition from deflagration to detonation.

To desensitize these crystals and make them easier to use under satisfactory safety conditions, a known technique is to modify the surface of said crystals by coating them so as:
to dissipate the heat (and therefore to slow down the combustion rate);
to absorb the intercrystalline shock energy and to prevent friction (deformable layer); and
to promote electric charge flow and thus reduce the static electricity sensitivity of the product.

The coating material is in general a polymer which may either be inert (U.S. Pat. No. 4,043,850 and DE 37 11 995) from the pyrotechnic standpoint or energetic (WO 2000/73245 and GB 2 374 867). There are cases in which the coating material consists of a polymeric binder filled with a metal in pulverulent form, said metal being involved with regard to electrostatic charges (EP 1 500 639).

The coating methods according to U.S. Pat. No. 4,043,850, DE 37 11 995, WO 2000/73245, GB 2 374 867 and EP 1 500 639 involve wet processing. The same applies to the method described in Journal of Polymer Materials, 21, 377-382, 2004 for the coating of CL-20. The technical problem of removing all traces of solvent then inevitably arises.

Moreover, when implementing all these coating methods, the quality of the coating (thickness and continuity of the film, morphology, etc.) cannot be satisfactorily controlled.

In general, the prior art offers no solution for controlling the deposition of a small predetermined amount of coating material on an explosive crystalline substance. However, controlling the quality and the thickness of the coating layer is of paramount importance for optimizing the compromise between the level of desensitization and the energetic capability of the coated explosive substance.

Those skilled in the art are therefore always seeking a method for minimizing the amount of coating, so as to obtain a continuous layer which is as thin as possible. The objective is in fact not to overly relativize the amount of active product to the detriment of an energetically less active or inactive material (the coating).

Of course, the method must also meet, on the one hand, the handling criteria for explosive materials (i.e. be able to be worked at temperatures low enough not to modify the structure of the molecules or crystals) and, on the other hand, environmental criteria relating to the use of volatile solvents (for example VOC emissions).
At the same time, methods have been developed for coating nanoparticles or microparticles, for electronic, medical, pharmaceutical or cosmetic applications. The method of depositing thin layers of organic or inorganic materials in a supercritical fluid on organic or inorganic particles is thus widely used in these fields. This method has the advantage of being carried out at low temperature and high pressure, thus permitting its application to organic compounds having a low decomposition temperature.

The supercritical fluid deposition method for coating with a thin metal layer consists in depositing a nanostructured thin metal layer (a layer ranging from an organization of nanoparticles to a uniform nanostructured film) on organic or inorganic compounds. This deposition is carried out by dissolving a metal precursor in a solvent. Said precursor, when decomposed, results in the precipitation of the metal on the compound to be coated. The method is described in patent application WO 2000/59622. The article “Design at the nanometer scale of multifunctional materials using supercritical fluid chemical deposition” by Samuel Marre et al., Nanotechnology, Volume 17, Number 18, Sep. 28, 2006, pp 4594-4599 describes the implementation of this method for depositing a copper film (consisting of copper nanoparticles) on submicronic silica beads. The method is carried out at temperatures ranging from 100° C. to 150° C. and under a pressure of 24 MPa. It consists in:
contacting, in a fluid containing one or more solvents, the particles to be coated and at least one metal precursor of the coating material, said particles being dispersed in the fluid under supercritical or slightly subcritical temperature and pressure conditions;
causing, within the fluid, the precursor of the coating material to be transformed in such a way that said material is deposited on the particles; and then
subjecting the fluid to temperature and pressure conditions such that said fluid is in the gaseous state in order to remove the solvent(s).

The method of coating with a thin continuous polymer layer in a supercritical medium is also well known, especially in the pharmaceutical and cosmetic fields. The deposition is carried out by dissolving the coating agent in a solvent and then by precipitating said coating agent on the compound to be coated by an antisolvent effect. Through this approach, it is possible for the deposited layer to be very finely controlled. Application WO 2004/91571 describes a method for depositing a polymer coating on particles using a supercritical fluid, for example supercritical carbon dioxide, as antisolvent, to which a polymer solution and an organic solvent are added, the particles being dispersed in said organic solvent. The coating is deposited when the supercritical fluid and the suspended particles are combined to cause the polymer to precipitate on the particles to be coated.
Methods for coating particles, whether or not they are energetic particles, with a polymer, in which said polymer is involved by being dissolved in a supercritical fluid, have also been described, especially in WO 99/19085, in the journal Industrial Engineering and Chemical Research, Vol. 44, No. 17, 2005, pp. 6523-6533, in DE 197 11 393 and in EP 0 706 821. The use of said methods is limited by the generally low solubility of polymers in supercritical fluids. It is therefore difficult, if not impossible, when using said methods to control the quality and the thickness of the coating generated.

Within such a context, the inventors have made the valuable contribution of selecting a coating technique under pressure and temperature setpoints, transposing it to the field of energetic explosive molecules, showing that said technique is suitable for depositing metal layers and polymer layers on the surface of the crystals of such molecules and showing that this technique can be implemented for generating such coatings, which are thin, continuous and uniform, over the entire surface of said crystals, in such a way that said crystals are desensitized without their energetic performance being significantly impaired.

According to the first subject of the present invention, this therefore relates to a method of desensitizing crystals of an energetic explosive substance by coating them. Characteristically, said method comprises:
the preparation of a solution containing, dissolved:
   at least one precursor of a coating material, said coating material being chosen from metals and mixtures thereof, and/or
   a coating material chosen from polymers and mixtures thereof;
the suspending of the crystals in said solution; and
the deposition, carried out within a fluid, outside the normal temperature and pressure conditions, preferably under supercritical conditions, of a metal and/or polymer film, advantageously a metal film or a polymer film, on the surface of said crystals (the film in question is generally a metal film or a polymer film, but a hybrid (metal+polymer) film is not excluded (see later)).

Under such conditions—outside normal temperature and pressure conditions, advantageously outside said normal conditions, in the liquid state of the fluid in question, very advantageously (i.e. preferably) under supercritical conditions—it is possible to obtain the expected result without having to reach elevated temperatures that the temperature-sensitive energetic explosive substance in question could not withstand.

Under such conditions—outside normal temperature and pressure conditions, advantageously outside said normal conditions, in the liquid state of the fluid in question, very advantageously (i.e. preferably) under supercritical conditions—it has proved possible to generate a metal coating and/or (generally or) a polymer coating on the surface of the crystals. It has also proved possible to generate such a thin, continuous and uniform coating over the entire surface of the crystals.

In the context of implementing the method of the invention, characteristically:
the coating material or its precursor is dissolved beforehand in a solvent. This leaves the possibility of optimizing the choice of the coating material (or its precursor)/solvent pair, of adjusting the concentrations of said material or precursor in said solvent and therefore of subsequently controlling the deposition of the coating material; and
said coating material is deposited at a temperature above room temperature (above 25° C. and generally above 30° C.) and at a pressure above atmospheric pressure. Advantageously, the method is carried out in the liquid state of the fluid in question (above the liquid/gas curve) outside said normal temperature and pressure conditions. Preferably, it is carried out under supercritical conditions.

The method in question, characteristically implemented (for depositing the coating material) under pressure and temperature setpoints, is of the type described for application in other fields (see above): method based on the reduction of a metal precursor in a medium under pressure and temperature setpoints, preferably a supercritical medium, for depositing a metal film; antisolvent method for depositing a polymer film. These two implementation variants will be discussed later.

The fluid, under pressure and temperature setpoints during implementation of the method of the invention, is advantageously carbon dioxide (CO₂). In general, this is the fluid most often used when it is intended to work under supercritical conditions since it has easily achievable critical co-ordinates (T_{c}=31° C. and P_{c}=7.38 MPa). Moreover, it is inexpensive, nontoxic and chemically stable. However, it is not excluded from the scope of the invention to carry out the method with the use, under supercritical conditions, of a fluid other than CO₂.

As indicated above, the method of the invention makes it possible to obtain thin, continuous uniform layers over the entire surface of the crystals. In particular, it is suitable for depositing:
a mass of a metal film and/or (advantageously or) a polymer film on each coated crystal that represents from 0.3 to 6% of the total mass of said coated crystal;
   and for advantageously depositing:
a mass of a metal film and/or (advantageously or) a polymer film, on each coated crystal, which represents from 2 to 4% of the total mass of said coated crystal.

Thus, the method of the invention is suitable in particular for depositing a layer of metal (Cu) particles with a thickness of around 50 nm, which corresponds to a measured mass content of 2.6%. The metal layer in question is a cover (continuous layer) consisting of nanoparticles.

Incidentally, it should be noted here that the method of the invention is not limited to obtaining coating layers as thin as this, but the fact that it does enable such layers to be obtained—which are thin but also continuous and uniform—is of particular interest.
A variant of the method of the invention implemented for depositing a metal film will now be presented. Incidentally, it should be noted that the deposition of such a film on the surface of crystals of energetic explosive substances is completely innovative.

The method of the invention is advantageously implemented for depositing a metal film of at least one metal chosen from nickel, copper, aluminum, titanium and zirconium and/or at least one oxide of such a metal. The metal film in question contains the corresponding metal(s) or the corresponding oxide(s), or else a mixture thereof.

The composition of the coating film is controlled by controlling the parameters of the method and more particularly the pressure and the temperature for implementing the method and the composition of the reaction medium.

The method of the invention, implemented for depositing a metal film, is advantageously of the type described in WO 2000/59622 and is based on the reduction of a metal precursor. This method comprises:
the preparation of a solution containing at least one metal precursor of at least one (coating) metal;
the suspending of the crystals in said solution;
the contacting of the solution obtained with a solvent fluid for said solution, outside the normal temperature and pressure conditions; and
the reduction, within said fluid, outside the normal temperature and pressure conditions, of said at least one precursor in such a way that said at least one metal is deposited on the surface of said crystals.

The method therefore comprises the contacting, under temperature and pressure setpoints, of crystals with a medium containing the dissolved precursor. By heating the medium, the precursor is decomposed on the surface of the crystals, causing a (metal) film to form.

Under the conditions indicated, i.e. outside normal temperature and pressure conditions (advantageously under such conditions, in the liquid state of the fluid in question; very advantageously under supercritical conditions), the fluid used is therefore a solvent for the solution containing said at least one precursor.

Said at least one precursor is advantageously chosen from metal acetates and acetylacetonates, advantageously from metal hexafluoroacetylacetonates. Such acetylacetonates have a high solubility in supercritical CO₂.

Said at least one precursor consists very advantageously of copper hexafluoroacetylacetonate.

Advantageously, the precursor is reduced in the presence of hydrogen (a reducing agent). Advantageously, a catalyst (such as Pd) may also be involved.

Purely by way of illustration, one way of implementing this variant of the method of the invention is explained below:
1. a known amount of precursor (Cu[hfac]₂) is dissolved in a cosolvent (an alcohol). The CL20 crystals are added and then dispersed by stirring. The cosolvent improves the solubility of the precursor (the Cu complex) in supercritical CO₂ (see later) and helps the reduction reaction;
2. the mixture is placed in a reactor pressurized with CO₂ and H₂;
3. the reactor (of constant volume) is heated until supercritical conditions are reached. Once the required temperature and pressure levels have been reached, the system is stabilized for a defined time in order to allow the precursor to decompose;
4. Cu nanoparticles are deposited on the surface of the crystals. The thickness of the deposited layer obviously depends, under defined conditions, on the time and the temperature. It also depends on the initial concentration of the precursor;
5. the coated crystals are then recovered either as a dispersion in the cosolvent (after decompression and removal of the CO₂+H₂) or in dry form (after the cosolvent is carried away by the gases).

In general, it may be pointed out that the thickness of the deposited metal film is controlled by, inter alia, the temperature, the contacting time and the concentration. The temperatures involved in the reduction vary depending on the precise nature of the precursors in question. They generally vary between 70° C. and 270° C., thereby enabling the energetic explosive substances to be below their decomposition temperatures.
A variant of the method of the invention implemented for depositing a polymer film will now be presented. Incidentally, it will be recalled here that such a film had been deposited, according to the prior art, by wet processing. The films obtained by the method of the invention are of better quality than those obtained according to the prior art (they are deposited, over the entire surface of the crystals, so as to be continuous and uniform, and advantageously with a very small thickness).

The method of the invention is advantageously implemented for the deposition of a polymer film of polybutadiene, especially of a hydroxytelechelic polybutadiene (HTPB), of polyurethane (PU), especially of a poly(diethylene glycol adipate) (PDEGA), of a polyoxyethylene/polyoxypropylene (POE/POP) copolymer, of polyglycidyl azide (PGA) or of a mixture of such polymers.

The method of the invention, implemented for depositing a polymer film, is advantageously of the type described in WO 2004/91571. As indicated above, this is an antisolvent method, which comprises:
the preparation of a solution of at least one polymer in a solvent;
the suspending of the crystals in said solution; and
the contacting of the suspension obtained with an antisolvent fluid, outside the normal temperature and pressure conditions, in order to induce the precipitation of said at least one polymer on the surface of said crystals.

The crystals are dispersed in a solution of at least one polymer. This solution is placed in a reactor, which is then pressurized with an antisolvent (missible with the first solvent), thereby causing said at least one polymer to precipitate on the surface of the crystals.

Purely by way of illustration, one way of implementing this variant of the method of the invention is presented below:
1. HTPB is dissolved in a solvent (for example, dichloromethane), the crystals, CL20 crystals for example, are added and the mixture is mechanically stirred;
2. this solution is placed in a reactor;
3. CO₂ (antisolvent and solvent for the first solvent) is injected under the required conditions. The reactor is then filled with the supercritical antisolvent, causing the HTPB to precipitate on the surface of the crystals;
4. the purge valves are then half opened and the traces of solvent (dichloromethane) are carried away by injecting a stream of CO₂ for example.

This variant of the method of the invention, implemented under supercritical conditions (the preferred method of implementation) may be termed the SAS (Supercritical AntiSolvent) variant.

Characterization techniques have demonstrated the uniform character of the layer (in the context of HTPB-coated or PGA-coated CL20). The quantity of layer deposited is expressed in percentages by weight, which are perfectly measurable and are familiar to a person skilled in the art (see above). HTPB layers deposited on silica beads according to the method of the invention have thicknesses of 7±2 nm for a mass content of 3% (the density of silica is obviously not that of CL20).

The methods of the invention, as presented above, are advantageously implemented:
with one metal precursor: however, it is in no way excluded for at least two such precursors to be used for depositing the same metal or for jointly depositing at least two metals; or
with one polymer: however, it is in no way excluded for at least two such polymers to be used for the combined deposition of said at least two polymers.

The combined deposition of at least one metal and at least one polymer is not completely excluded within the context of the invention. Of course, controlling such a hybrid deposition is more difficult. This has to involve, upstream, at least one metal precursor and at least one polymer in solution and the temperature and pressure conditions have to be determined, in particular when the at least two intended reactions (reduction of said at least one precursor into at least one metal, and precipitation of said at least one polymer) take place.

Finally, with reference to the method of the invention, it should be pointed out that it is advantageously implemented for coating, under pressure and temperature setpoints, an energetic explosive substance of the organic secondary explosive type, especially chosen from:
octahydro-1,3,5,7-tetranitro-1,3,5,7-tetrazocine (HMX or octogen);
hexahydro-1,3,5-trinitro-1,3,5-triazine (RDX or hexogen or cyclonite);
2,4,6,8,10,12-hexanitrohexaazaisowurtzitane (CL20 or HNIW); and
4,10-dinitro-2,4,6,8,12-tetraoxa-4,10-diazaisowurtzitane (TEX).

By implementing the perfectly controllable and reproducible method of the invention, the coating on the explosive substances may be characterized by unmatched uniformity and thinness. The sensitivity of the coated explosive substances may thus be reduced, while still maintaining energetic levels close to those of the uncoated substance.

The second subject of the present invention relates to coated crystals of an energetic explosive substance, which crystals are obtainable by the method described above, namely a method of coating them with a metal film and/or (advantageously or) a polymer film, implemented, characteristically, outside the normal temperature and pressure conditions. Said coated crystals are new because of the nature of the film in question and/or because of the characteristics thereof (quality [it is uniform and continuous over the entire surface of the crystals] and/or amount deposited).

The crystals coated with a metal film are new per se.

The crystals coated with a polymer film (or even a hybrid metal/polymer film) are new because of the characteristics of the coating. Said characteristics, which are new and particularly advantageous, result from the new implementation of the coating, under pressure and temperature setpoints with a suspension, containing, in solution, the coating material or at least one precursor thereof (said material or said at least one precursor thereof having been dissolved upstream in a solvent (the nature of said solvent and the concentration of said material or of said at least one precursor within said solvent possibly having been optimized) (see above).

The coated crystals of the invention advantageously have:
a mass of the metal film and/or (advantageously or) polymer film that represents, for each coated crystal, from 0.3 to 6% of its total mass; and very advantageously have:
a mass of the metal film and/or (advantageously or) polymer film that represents, for each coated crystal, from 2 to 4% of its total mass.

In view of the above description of the coating method, it will be understood that the coated crystals of the invention are advantageously:
coated with a metal film of at least one metal chosen from nickel, copper, aluminum, titanium, zirconium and/or at least one oxide of such a metal; or
coated with a polymer film of polybutadiene, especially of a hydroxytelechelic polybutadiene (HTPB), of polyurethane (PU), especially of a poly(diethylene glycol adipate) (PDEGA), of a polyoxyethylene/polyoxypropylene (POE/POP) copolymer, of polyglycidyl azide (PGA) or of a mixture of these polymers;
   and that said crystals are advantageously crystals of an organic secondary explosive, especially chosen from those identified earlier in the present text.

Finally, the third subject of the present invention relates to energetic materials incorporating in their composition crystals of the invention, i.e. crystals coated per se and/or desensitized crystals obtained by the method of the invention. Said energetic materials contain an effective amount of said coated or desensitized crystals. In fact, they generally consist of said crystals or contain them, in an effective amount, in a binder.

The invention will now be illustrated in an entirely nonlimiting manner, by the appended figures and the following examples:

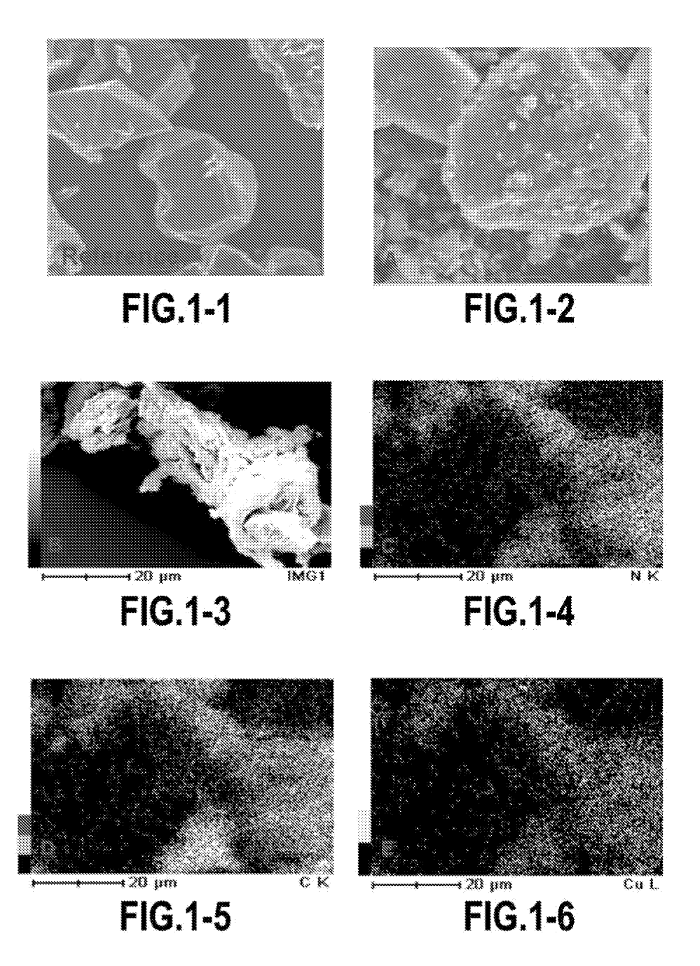

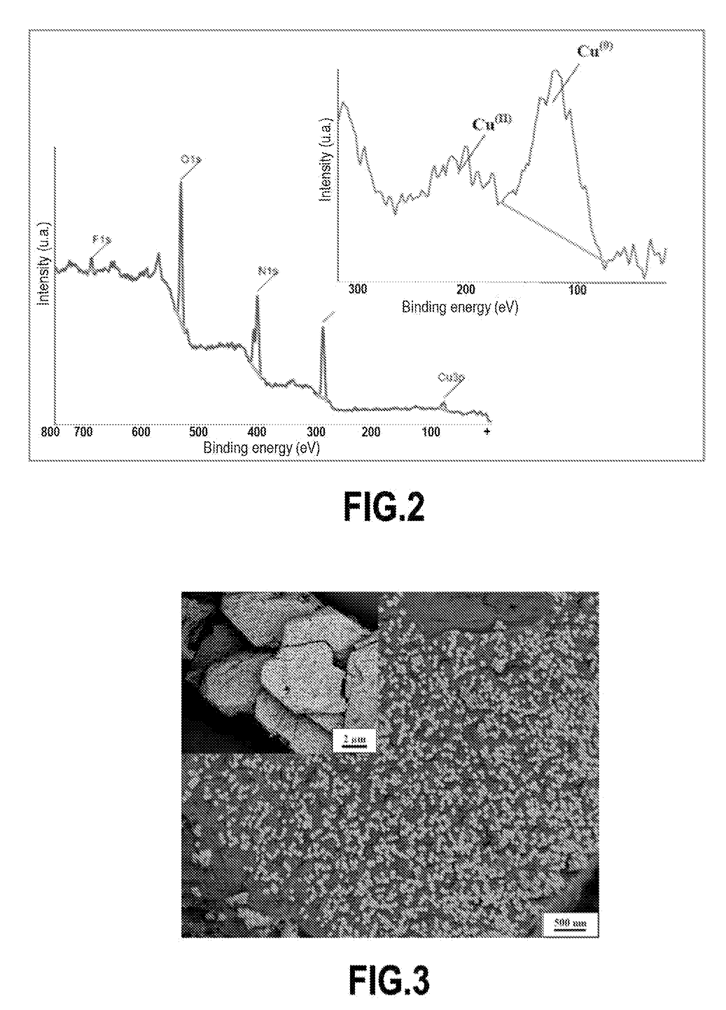

FIGS. 1-1 to 1-6 show the SEM (scanning electron microscope) analysis of an initial ε-CL20 crystal (FIG. 1-1), and such a CL20 crystal coated with copper (FIG. 1-2) according to the method of the invention from Example 1.5, followed by a series of EDX elementary maps (using the energy dispersive X-ray technique associated with SEM analysis) of the surface of such a CL20 crystal coated according to the invention with copper: SEM image of the Cu-coated crystal (FIG. 1-3), and EDX mapping of this coated crystal making it possible to identify nitrogen (FIG. 1-4), carbon (FIG. 1-5) and copper (FIG. 1-6);

FIG. 2 shows the X-ray photoelectron spectroscopy (XPS) spectrum of a CL20 crystal coated with copper according to the method of the invention from Example 1.5 (the intensity is plotted on the y-axis in arbitrary units (a.u.)). The enlargement of the copper peak allows us to see the proportions of metallic copper (right-hand peak) and of copper in oxidized form (precursor, copper oxide—left-hand peak) deposited on the surface of the CL20 crystal. The metallic copper is predominantly present on the surface of the CL20;

FIG. 3 shows a high-resolution scanning electron image of CL20 crystals coated with Cu according to the method of Example 1.4; and

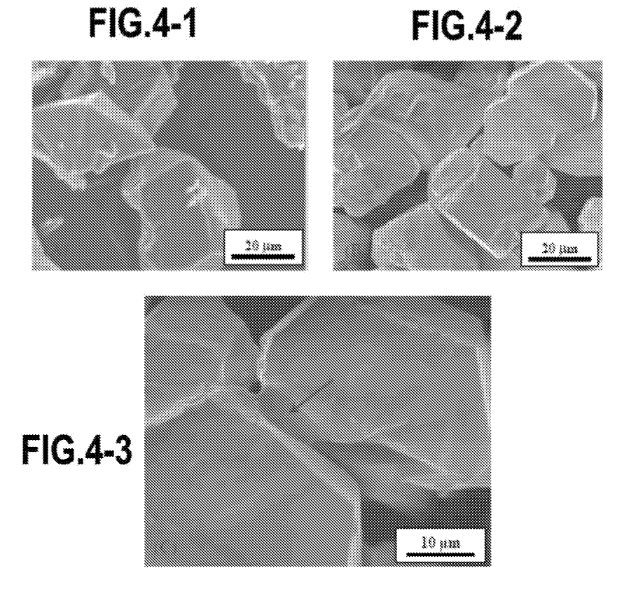

FIGS. 4-1 to 4-3 show scanning electron micrographs of CL20 crystals with no coating (FIG. 4-1), followed by such CL20 crystals coated with HTPB (FIG. 4-2) (FIG. 4-3) according to the method of the invention of Example 3. The presence of HTPB is clearly visible at the places indicated by the arrows.

In the case of the examples, the reaction was carried out, in batch mode, in a high-temperature high-pressure reactor of 255 cm³ internal volume.

### EXAMPLE 1

### Coating of CL20 Crystals with a Copper Film

Example 1 relates to the application of the method of the invention to the coating of the explosive substance 2,4,6,8,10,12-hexanitrohexaazaisowurtzitane (HNIW or CL20) with a copper film.

### Supercritical Fluid Deposition Conditions for Example 1.5 (Table 1)

The trial was carried out by preparing a solution comprising 15 ml of isopropanol+1.2 g of Cu(hfac)₂.H₂O+60 mg of Pd(hfac)₂.H₂O. Added to the solution were 3.5 g of CL20, the suspension obtained then being placed at the bottom of the reactor. Said reactor was then injected with H₂ at 2.5 MPa, the pressurization up to 9 MPa then being completed with CO₂. The chamber was then brought to the desired conditions (100° C., 22 MPa) and held there for a relatively short exposure time (45 minutes). Next, the reactor was cooled and then depressurized. The powder, corresponding to copper-coated CL20, was recovered from the bottom of the reactor in isopropanol.

### Characterization of the Products Obtained from Example 1.5 (Table 1)

The copper-coated CL20 had a gray/black color (coppery red under an optical microscope), whereas the CL20 before coating was white.

The copper coating on the CL20 crystals was characterized by 5 techniques:
scanning electron microscopy (SEM);
energy dispersion X-ray (EDX) analysis;
X-ray photoelectron spectroscopy (XPS);
atomic absorption.

The morphology of the copper-coated CL20 crystals was characterized by scanning electron microscopy (SEM). In addition, EDX (X-ray analytical technique associated with SEM) was used for surface elemental analysis so as to determine the elements present (FIGS. 1).

The SEM image obtained shows that the surface of the CL20 crystals is covered with nanoparticles having a size between 50 and 300 nm (FIG. 1-2).

The EDX analysis provided surface maps of the specimen for each element (FIGS. 1-4, 1-5 and 1-6). The maps of certain constituent elements (N and C) of the CL20 again show the shape of the crystal of the initial image (FIG. 1-3), whereas FIG. 1-6 corresponds to copper detection. It can be seen that copper is present over the entire surface of the crystal.

To determine the degree of oxidation of the copper on the surface of the CL20 crystals, XPS characterizations have been carried out (FIG. 2).

In this figure, peaks corresponding to the binding energies of carbon, oxygen, nitrogen, copper and palladium atoms may be clearly distinguished. The small amount of palladium comes from the palladium precursor (Pd(hfac)₂) that catalyzes the reduction of the copper precursor. The enlargement of the copper peak reveals the proportions of metallic copper (right-hand peak) and of copper in oxidized form (precursor, copper oxide—left-hand peak). The metallic copper is predominantly present on the surface of the CL20.

The copper present on the surface was quantified by atomic absorption. To do this, the specimens were washed twice with isopropanol and then filtered so as to remove the copper particles not deposited on the surface of the CL20. A gray/black powder was recovered, this being dispersed in a 30% v/v nitric acid solution. The CL20 was not modified during this operation, whereas the copper dissolved to form a quantifiable Cu²⁺ solution. The copper(II) solution could then be quantified. The percentage of copper by weight present on the surface was 2.76% under the conditions of Example 1.5. However, this value can be varied by varying the reaction parameters (initial precursor concentration, catalyst concentration, sequences of precursor and catalyst injection into the reactor, reaction time) between 0.3 and 30%, as Table 1 shows. A person skilled in the art will know how to adjust these parameters according to his requirements.

TABLE 1
Percentage of Cu deposited on CL20 crystals according to the reaction parameters.

| Reaction parameters | | | | | | | | |
|---|---|---|---|---|---|---|---|---|
| (T = 100° C., P = 22 MPa, Stirring speed = 150 rpm) | | | | | | | | |
| | CL20 | Cu(hafc)₂ | iPrOH | Pd(hfac)₂ | H₂ | CO₂ | Reaction | % Cu |
| Ex. No. | (mg) | (mg) | (ml) | (mg) | (MPa) | (MPa) | time (min) | deposited |
| 1.1 | 202.1 | 251.2 | 10 | / | 2.5 | 6.5 | 240 | 0.4 |
| 1.2 | 201.1 | 1250 | 10 | / | 2.5 | 6.5 | 240 | 0.3 |
| 1.3 | 201.7 | 250 every | 2 every | / | 2.5 | 6.5 | 600 | 1 |
| | | 120 min | 120 min | | | | | |
| 1.4 | 201.4 | 104.2 | 10 | 10.8 | 2.5 | 6.5 | 150 | 1.7 |
| 1.5 | 350 | 1200 | 15 | 60 | 2.5 | 6.5 | 45 | 2.76 |
| 1.6 | 200.4 | 1250 | 10 | 52 | 2.5 | 6.5 | 240 | 29.4 |

When the amount of copper deposited is small, the SEM images show that the copper nanoparticles deposited on the surface of the crystal are non-contiguous. This is the case for the coating shown in FIG. 3 obtained under the reaction parameters of Example 1.4.

### Properties of the Material Obtained According to Example 1.5

Sensitivity

The sensitivity of the copper-coated CL20 crystals of Example 1.5 was evaluated by carrying out the standardized shock sensitivity (SS*), friction sensitivity (FS**), electric spark sensitivity (ES***) and deflagration-to-detonation transition (DDT****) tests. Table 2 below gives the results obtained for comparison with the initial ε-CL20.

TABLE 2
Comparison of the sensitivity tests for the
reference ε-CL20 crystals and the product obtained in
Example 1.5.

| | Reference ε-CL20 | Substance obtained in |
|---|---|---|
| Specimen | crystals | Example 1.5 |
| SS* (J) | 1.4 | 4.1 ± 0.5 |
| FS** (N) | 73 | 103 ± 11 |
| ES*** (mJ) | 116 | >712 |
| DDT**** | Combustion up to 50 mm | Combustion from 150 mm |
| | Explosion at 75 mm | Explosion at 200 mm |

*SS: The test carried out corresponds to that described in the NFT 70-500 standard, which is itself similar to the UNO 3a)ii) test resulting from the “Recommendations relatives au Transport des marchandises dangereuses - manuel d'épreuves et de critères [Recommendations relating to the transport of Dangerous Goods: Manual of tests and criteria], revised fourth edition, ST/SG/AC.10/11/Issue 4, ISBN 92-1-239083-8ISSN 1014-7179. By a minimum series of 30 tests, the energy leading to 50% of positive results (using the Bruceton method of treating the results) of an explosive material subjected to the shocks of a drop hammer. The material to be tested is confined in a steel device consisting of two discs and a guiding ring. By modifying the mass and the drop height of the hammer, the energy may be varied from 1 to 50J.
**FS: The test carried out corresponds to that described in the NF T 70-503 standard, which itself is similar to the UNO 3b)ii) test. By a minimum series of 30 tests, the Bruceton method is used to determine the force giving rise to 50% of positive results of an explosive material subjected to friction. The material to be tested is placed on a porcelain plate of defined roughness, which is moved in a single back-and-forth movement with an amplitude of 10 mm and a speed of 7 cm/s in the empty state, relative to a porcelain peg which is resting on the material. The force applied to the porcelain peg, which bears on the material, may vary from 7.8 to 353 N.
***ES: The test carried out is a test developed by the Applicant, with no NF or UNO equivalent. The material to be tested, placed in a boat of 10 mm diameter and 1.5 mm height, is positioned between 2 electrodes and is subjected to an electric spark of energy varying from 5 to 726 mJ. The system is observed to see whether or not there is a pyrotechnic event, and the energy threshold at which initiation of the material no longer takes place is determined. This value is confirmed by 20 successive tests.
****DDT: The test consists in measuring the capability of a mass of divided material (particle bed) of passing from combustion to detonation after ignition, carried out on the surface of the bed, specifically in the case of CL20, otherwise at the base of the powder bed. The SNPE test No. 55 consists in filling a metal tube of 40 mm diameter and variable height. The tube is open at one end. The critical height resulting in a violent reaction is determined from the effects noticed on the tube.

The presence of copper on the surface desensitizes the material since it is observed that there is a substantial reduction both in shock sensitivity and friction sensitivity and practically no sensitivity to static electricity. Moreover, as regards the DDT results, the critical height is increased by a factor of greater than 2.

Energetic Power

Table 3 below compares the density ρ, impulse Is and specific volume impulse Is×ρ calculated for three types of propellants comprising, in their composition, either ε-CL20 or copper-coated CL20 according to Example 1.5.

TABLE 3
Comparison of the ρ, Is and Is × ρ values
obtained by calculation with two different Azalanes ® compositions
(Al: 18% w/w; ammonium perchlorate: 12% w/w + binder +
explosive substance).

| | | | Coated | | | |
|---|---|---|---|---|---|---|
| Bulk | Binder | ε-CL20 | product | ρ | Is | Is × ρ |
| composition | (%) | (%) | of ex. 1.5 | (g/cm³) | (s) | (s · g/cm³) |
| Reference | 27 | 43 | — | 1.879 | 272.1 | 511.2 |
| composition | | | | | | |
| Composition | 24 | — | 43 + 3 | 1.935 | 264.1 | 511.0 |
| containing | | | | | | |
| the product | | | | | | |
| of Example | | | | | | |
| 1.5 | | | | | | |

The density of the coated substance increases slightly relative to the initial substance because of the presence of about 3% copper. In contrast, the specific impulse of copper-coated CL20 according to Example 1.5 is reduced. However, the value of IS×ρ, which takes into account the specific impulse and the density of the product is practically the same as that of a composition using ε-CL20.

### EXAMPLE 2

### Coating of TEX Crystals with a Copper Film

Example 2 relates to the application of the method for coating the explosive substance 4,10-dinitro-2,4,6,8,12-tetraoxa-4,10-diazaisowurtzitane, called TEX, with a copper film.

Table 4 below gives the two reaction parameters and the amount of copper deposited, quantified using the method described in Example 1.

TABLE 4
Percentage of Cu deposited on TEX crystals according to the reaction parameters

| Reaction parameters | | | | | | | | |
|---|---|---|---|---|---|---|---|---|
| (T = 100° C., P = 22 MPa, Stirring speed = 150 rpm) | | | | | | | | |
| | | | | | | | Reaction | |
| | | Cu(hafc)₂ | iPrOH | Pd(hfac)₂ | H₂ | CO₂ | time | % Cu |
| Ex. No. | TEX (mg) | (mg) | (ml) | (mg) | (MPa) | (MPa) | (min) | deposited |
| 2.1 | 200 | 100 | 3 | 10 | 2.5 | 6.5 | 150 | 2.2 |
| 2.2 | 200 | 100 | 3 | 20 | 2.5 | 6.5 | 150 | 2.8 |

### EXAMPLE 3

### Coating of CL20 Crystals with an HTPB (hydroxytelechelic polybutadiene) Film

Example 3 relates to the application of the method to the coating of the explosive substance 2,4,6,8,10,12-hexanitrohexaazaisowurtzitane (HNIW or CL20) with an HTPB polymer film.

Operating Method

The principle of depositing a polymer on the surface of CL20 crystals is based on an antisolvent method under supercritical conditions.

The polymer is dissolved in a dichloromethane (DCM) solution to which the crystals of explosive substance are added, these not being soluble in DCM. The crystal-laden solution is placed in the reactor, which is then pressurized with a supercritical antisolvent (scCO₂, miscible with DCM), thereby precipitating HTPB on the surface of the crystals of the explosive substance. The DCM is removed by slow depressurization and flushing with an antisolvent stream for a defined time (drying time). The polymer-coated crystals are recovered from the bottom of the reactor in the form of a dry powder.

The polymer coating on the CL20 crystals was characterized by SEM and by UV-visible spectroscopy.

UV-visible spectroscopy enables the amount of polymer deposited on the surface of the crystals to be quantified. The quantification principle consists in redissolving the deposited polymer by placing a certain amount of coated crystals in DCM. The solution is then filtered and the collected polymer is quantified.

The reaction conditions of Example 3 and the percentage of HTPB are given in Table 5 below.

TABLE 5
Percentage of HTPB deposited on CL20 crystals
according to the reaction parameters.

| Reaction parameters | | | | | | |
|---|---|---|---|---|---|---|
| (T = 60° C., P = 12 MPa; Stirring speed = 150 rpm) | | | | | | |
| | CL20 | DCM | HTPB | CO₂ | Drying time | % HTPB |
| Example | (g) | (ml) | (mg) | (MPa) | (min) | deposited |
| 3 | 6 | 50 | 180 | 12 | 120 | 3% |

Characterization of the Product

The HTPB-coated CL20 crystals are of white color and have an expanded texture compared with the initial powder (FIG. 4).

The sensitivity of the HTPB-coated CL20 crystals of Example 3 was determined by carrying out the standardized tests described in Example 1. Table 6 below gives the results obtained for comparison with the initial ε-CL20.

TABLE 6
Comparison of the sensitivity tests for the
initial ε-CL20 substance and the coated product of
Example 3.1

| Specimen | ε-CL20 | Product of Example 3.1 |
|---|---|---|
| SS (J) | 1.4 | 2.7 ± 0.3 |
| FS (N) | 73 | 157 ± 17 |
| ES (mJ) | 116 | >712 |
| DDT | Combustion up to 50 mm | Combustion from 350 mm |
| | Explosion at 75 mm | No explosion in the range |
| | | studied |

By coating with HTPB, it is possible to reduce the friction sensitivity FS and the static electricity sensitivity and, to a lesser extent, the shock sensitivity SS. The coating reduces the sensitivity to the DDT test very significantly.

1. A method of desensitizing crystals of an energetic explosive substance by coating them, comprising:
the preparation of a solution containing, dissolved:
at least one precursor of a coating material, said coating material being chosen from metals and mixtures thereof, and/or
a coating material chosen from polymers and mixtures thereof;
the suspending of the crystals in said solution; and
the deposition, carried out within a fluid, outside the normal temperature and pressure conditions, preferably under supercritical conditions, of a metal and/or polymer film, advantageously a metal film or a polymer film, on the surface of said crystals.

2. The method according to claim 1, wherein said fluid is CO₂.

3. The method according to claim 1, wherein:
the mass of said deposited metal or polymer film represents, for each coated crystal, from 0.3 to 6% of its total mass, and in that,
advantageously, the mass of said deposited metal or polymer film represents, for each coated crystal, from 2 to 4% of its total mass.

4. The method according to claim 1, comprising the deposition of a metal film consisting of at least one metal chosen from nickel, copper, aluminum, titanium and zirconium and/or of at least one oxide of such a metal.

5. The method according claim 1, comprising:
the preparation of a solution containing at least one metal precursor of at least one metal;
the suspending of the crystals in said solution;
the contacting of the solution obtained with a solvent fluid for said solution, outside the normal temperature and pressure conditions; and
the reduction, within said fluid, outside the normal temperature and pressure conditions, of said at least one precursor in such a way that said at least one metal is deposited on the surface of said crystals.

6. The method according to claim 5, wherein:
said at least one precursor is chosen from metal acetates and metal acetylacetonates, advantageously from metal hexafluoroacetylacetonates, and in that
said at least one precursor consists very advantageously of copper hexafluoroacetylacetonate.

7. The method according claim 5, wherein said reduction is carried out in the presence of hydrogen.

8. The method according to claim 1, comprising the deposition of a polymer film of polybutadiene, especially of a hydroxytelechelic polybutadiene, of polyurethane, especially of a poly(diethylene glycol adipate), of a polyoxyethylene/polyoxypropylene copolymer, of polyglycidyl azide or of a mixture of such polymers.

9. The method according to claim 1, comprising:
the preparation of a solution of at least one polymer in a solvent;
the suspending of the crystals in said solution; and
the contacting of the suspension obtained with an antisolvent fluid, outside the normal temperature and pressure conditions, in order to induce the precipitation of said at least one polymer on the surface of said crystals.

10. The method according to claim 1, wherein the high-energy explosive substance is an organic secondary explosive, especially chosen from octahydro-1,3,5,7-tetranitro1,3,5,7-tetrazocine, hexahydro-1,3,5-trinitro-1,3,5-triazine, 2,4,6,8,10,12-hexanitrohexaazaisowurtzitane and 4,10-dinitro-2,4,6,8,12-tetraoxa-4,10-diazaisowurtzitane.

11. Coated crystals of an energetic explosive substance, obtainable by the method as claimed in claim 1.

12. The crystals according to claim 11, these being coated with a metal film.

13. The crystals according to claim 11, these being coated with a polymer film.

14. The crystals according to claim 11, wherein:
the mass of said metal or polymer film represents, for each coated crystal, from 0.3 to 6% of its total mass and in that,
advantageously, the mass of said metal or polymer film represents, for each coated crystal, from 2 to 4% of its total mass.

15. The crystals according to claim 11, wherein they are coated with a metal film comprising at least one metal chosen from nickel, copper, aluminum, titanium, zirconium and/or with at least one oxide of such a metal.

16. The crystals according to claim 11, which are coated with a polymer film of polybutadiene, of especially of a hydroxytelechelic polybutadiene, of polyurethane, especially of a poly(diethylene glycol adipate), of a polyoxyethylene/polyoxypropylene copolymer, of polyglycidyl azide or a mixture of these polymers.

17. The crystals according to claim 11, wherein the high-energy explosive substance is an organic secondary explosive, especially chosen from octahydro-1,3,5,7-tetranitro-1,3,5,7-tetrazocine, hexahydro-1,3,5-trinitro-1,3,5-triazine, 2,4,6,8,10,12-hexanitrohexaazaisowurtzitane and 4,10-dinitro-2,4,6,8,12-tetraoxa-4,10-diazaisowurtzitane.

18. Energetic materials, comprising an effective quantity of coated crystals of an energetic explosive substance and/or desensitized crystals obtainable by the method according to claim 1.
